(19) United States
(12) Patent Application Publication
(10) Pub. No.: US 2017/0123979 A1
(43) Pub. Date: May 4, 2017

(54) SYSTEMS, DEVICES, AND METHODS FOR HANDLING PARTIAL CACHE MISSES

(71) Applicant: Intel Corporation, Santa Clara, CA (US)

(72) Inventors: Ambili V, Bangalore (IN); Dileep Kurian, Bangalore (IN)

(73) Assignee: INTEL CORPORATION, Santa Clara, CA (US)

(21) Appl. No.: 14/925,959

(22) Filed: Oct. 28, 2015

(51) Int. Cl. G06F 12/08

(52) U.S. Cl. CPC G06F 12/0802; G06F 2212/60

(57) ABSTRACT

Devices and systems for managing partial cache misses in multiple cache lines of a memory cache are disclosed and described, including associated methods.

### BACKGROUND

Computational devices and systems have become integral to the lives of many people across a range of implementations, from the personal mobile space to large networking systems. Such devices and systems not only provide enjoyment and convenience, but can greatly increase productivity, creativity, social awareness, and the like. One consideration that can affect such beneficial effects relates to the speed and usability of the devices themselves. Slow performance speeds, short battery life, and the like, can limit or even eliminate these beneficial effects for many.

One internal component of many computational devices and systems that can greatly affect speed and power consumption is a cache memory. Cache memory is a small memory component designed to temporarily store frequently used data. Because cache memory is faster than system memory, storing such frequently used data therein can provide a performance boost, as well as a reduction in power consumption in many cases.

### BRIEF DESCRIPTION OF THE DRAWINGS

FIG. 1 is a state diagram showing various states of a cache line in accordance with an invention embodiment;

FIG. 2 is a schematic diagram of logic circuitry in accordance with an invention embodiment;

FIG. 3 is a schematic diagram of empty bit reset circuitry in accordance with an invention embodiment;

FIG. 4 is a flow chart of a write request flow in accordance with an invention embodiment;

FIG. 5 is a flow chart of a read request flow in accordance with an invention embodiment;

FIG. 6 is a flow diagram of a method for processing partial write hits in a cache memory in accordance with an invention embodiment;

FIG. 7 is a flow diagram of a method for processing partial read hits in a cache memory in accordance with an invention embodiment; and

FIG. 8 is a block diagram view of a system for processing partial cache hits in accordance with an invention embodiment.

### DESCRIPTION OF EMBODIMENTS

Although the following detailed description contains many specifics for the purpose of illustration, a person of ordinary skill in the art will appreciate that many variations and alterations to the following details can be made and are considered to be included herein.

Accordingly, the following embodiments are set forth without any loss of generality to, and without imposing limitations upon, any claims set forth. It is also to be understood that the terminology used herein is for the purpose of describing particular embodiments only, and is not intended to be limiting. Unless defined otherwise, all technical and scientific terms used herein have the same meaning as commonly understood by one of ordinary skill in the art to which this disclosure belongs.

In this disclosure, “comprises,” “comprising,” “containing” and “having” and the like can have the meaning ascribed to them in U.S. patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. patent law. “Consisting essentially of” or “consists essentially of” have the meaning generally ascribed to them by U.S. patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open ended term in this specification, like “comprising” or “including,” it is understood that direct support should be afforded also to “consisting essentially of” language as well as “consisting of” language as if stated explicitly and vice versa.

“The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein.

As used herein, “enhanced,” “improved,” “performance-enhanced,” “upgraded,” and the like, when used in connection with the description of a device or process, refers to a characteristic of the device or process that provides measurably better form or function as compared to previously known devices or processes. This applies both to the form and function of individual components in a device or process, as well as to such devices or processes as a whole.

As used herein, “coupled” refers to a relationship of physical connection or attachment between one item and another item, and includes relationships of either direct or indirect connection or attachment. Any number of items can be coupled, such as materials, components, structures, layers, devices, objects, etc.

As used herein, “directly coupled” refers to a relationship of physical connection or attachment between one item and another item where the items have at least one point of direct physical contact or otherwise touch one another. For example, when one layer of material is deposited on or against another layer of material, the layers can be said to be directly coupled.

Objects or structures described herein as being “adjacent to” each other may be in physical contact with each other, in close proximity to each other, or in the same general region or area as each other, as appropriate for the context in which the phrase is used.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. However, it is to be understood that even when the term “about” is used in the present specification in connection with a specific numerical value, that support for the exact numerical value recited apart from the “about” terminology is also provided.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 1.5, 2, 2.3, 3, 3.8, 4, 4.6, 5, and 5.1 individually.

This same principle applies to ranges reciting only one numerical value as a minimum or a maximum. Furthermore, such an interpretation should apply regardless of the breadth of the range or the characteristics being described.

Reference throughout this specification to “an example” means that a particular feature, structure, or characteristic described in connection with the example is included in at least one embodiment. Thus, appearances of the phrases “in an example” in various places throughout this specification are not necessarily all referring to the same embodiment.

### Example Embodiments

An initial overview of technology embodiments is provided below and specific technology embodiments are then described in further detail. This initial summary is intended to aid readers in understanding the technology more quickly, but is not intended to identify key or essential technological features, nor is it intended to limit the scope of the claimed subject matter.

As a general description, a cache is a memory component designed to increase memory performance by temporarily storing data that is likely to be used again. Such data may be a copy of data stored in the main memory, data stored in a backing or other data store, a computational result, or the like. A cache can include a pool of entries with associated data that is generally a copy of data stored elsewhere. Each entry includes a tag that links the data to the corresponding data stored elsewhere.

When a cache client, such as a central processing unit (CPU), for example, has a read request to access data or a write request to store data, the cache is checked first to determine whether or not the requested data is present. If an entry is found in the cache with a tag matching the requested data, then the cache data is served to fill the read request. A cache “hit” thus occurs when the requested data is located within the cache. As cache memory is generally faster than other data stores, such as main memory, backing stores, etc., and therefore, using the cache data results in a performance increase for the data access. If an entry is not found in the cache with a tag matching the requested data, a cache “miss” occurs. Depending on the specifics of the data request, a cache miss is generally handled by copying a corresponding cache line of data associated with the requested data from the data store to the cache. In the case of a read request, the client uses the fetched data to fulfill the request. In the case of a write request, the requested data is written over the fetched data in the cache line. A cache miss often results in another entry in the cache being ejected to make room for the incoming requested data.

In the case of a write hit, the request is filled by writing the requested data to the associated cache line of the cache. The cache entry for the cache line containing the written data is marked as having been modified, which can be referred to as “dirty.” Thus the cache line has a status bit or “dirty bit” to signify that data in the cache line has been modified, sometimes referred to as a “dirty line.” When the client writes to the cache line, the dirty bit is set to true to signify that the data in the cache line has not been written back to the data store (e.g., main memory). When a cache line is to be replaced, such as when a write miss occurs, its corresponding dirty bit is checked to see if the cache block (e.g., cache line) needs to be written back to the data store before being replaced, or if it can simply be removed.

A partial cache miss is a cache miss where the size of the requested write data is less than the cache line size to a location that is not present in the cache. It is noted that partial cache misses can also be referred to as partial cache hits. In traditional memory systems, partial cache misses are often treated as misses, where the corresponding cache line is fetched from the data store, and the requested data is written there over. Treating partial misses as misses leads to unwanted fetches, and a decrease in computing performance and an increase power consumption, particularly for write-intensive applications, or for scenarios where the percentage of dirty lines never being read again is high. The alternative of providing word or byte level status bits for each cache line could prove prohibitive in size.

Some embodiments allow for management of partial write misses. In one example, circuitry having a buffer “Partial_Dirty_Buffer” (PDB) is utilized to track a number of partial dirty cache lines. In some cases, the PDB can be a fully associative buffer. A partial dirty cache line is a cache line that is only partially full of dirty or modified data. In some cases, a cache controller keeps track of partial dirty lines with status bits, and can perform a look-up of the PDB to take appropriate action. Each cache line has at least two status bits, a valid status bit and a dirty status bit (or a modified status bit) that indicate the current status of the line. An empty cache line will have the valid bit set to 0 (or false). When data is fetched from the main memory (or other data store) and populated in a cache line, the valid status bit is set to 1 (or true).

In one implementation example, the PDB can include a word status bit for each word location in the cache line. Thus, a word status bit is a status indicator for the associated word location in the cache line as to whether or not the data at that location has been modified, or in other words, is dirty. The cache controller can thus determine, through a PDB lookup, which word locations in a given cache line contain modified data and which word locations contain unmodified data. Table 1 shows one possible implementation of the PDB structure.

TABLE 1

| | Word Status Bits (W-bits | Empty (1 bit) |
|---|---|---|
| TAG (n-bits) | for a W-word Cache Line) | (i.e. Valid Status Bit) |
| <tag1> | <XXXXXXXXXX> | 1 |
| <tag2> | <XXXXXXXXXX> | 1 |
| . . . | | |
| <tag10> | <XXXXXXXXXX> | 1 |

The PDB allows partial dirty cache lines to be tracked, and the data located therein can be utilized by a cache client. By such a methodology, performance of a memory system can be greatly increased because a main memory fetch of the data associated with the cache line is not required for every partial cache miss.

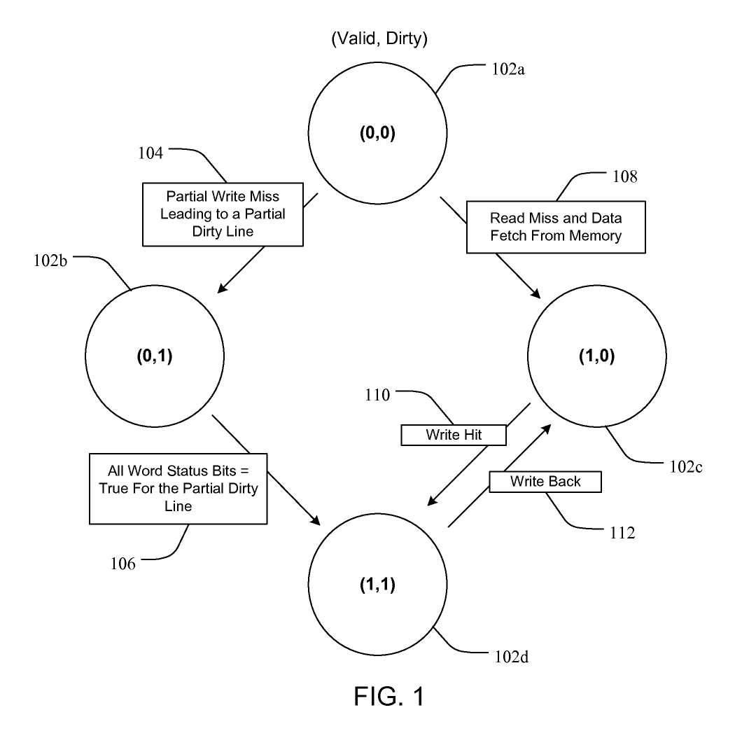

FIG. 1 is a state diagram of a cache line showing the valid status bit and the dirty status bit (Valid, Dirty) for each of the 4 states, represented by the 4 circles 102a-d. For example, state (0,0) 102a has both the valid and dirty bits set to 0 (or false), while state (0,1) 102b has the valid status bit set to 0 and the dirty status bit set to 1 (or true). Table 2 shows the states of the cache line for the various combinations of the valid state bit and the dirty state bit.

TABLE 2

| (Valid, Dirty) | State | On Access |
|---|---|---|
| (0, 0) 102a | Invalid | Miss |
| (1, 0) 102c | Valid | Hit |
| (0, 1) 102b | Partial | Dirty Miss |
| (1, 1) 102d | Valid | Dirty Hit |

On a partial write miss 104 to a cache line with a (0,0) bit state 102a, the dirty bit associated with that cache line is updated to 1 (or true), leading to a (0,1) bit state 102b. In addition, the partial hit data, or in other words the hit portion of the partial write miss, is written to the cache line, and the word status bits corresponding to the location of the partial hit data are updated in the PDB. Upon each subsequent partial write miss 104 to an already partial dirty cache line 102b, the cache controller performs a lookup of the PDB and updates the word status bits corresponding to the partial hit data written to the cache line. If the partial dirty cache line 102b has all of the associated word status bits in the PDB set to 1 (or true) 106, then the cache line is set to a (1,1) bit state 102d, and the reference to the cache line is ejected from the PDB. This frees up space for another reference to a partial dirty cache line to be stored in the PDB.

Upon a read miss 108 of a cache line with a (0,0) bit state 102a, the data associated with the read request is fetched from main memory and the valid bit for that cache line is set to 1, leading to a (1,0) bit state 102c. Upon a subsequent write hit 110, the data from the request is written to the cache line and the associated dirty bit is set to 1, leading to a (1,1) bit state 102d. This bit state 102d signifies that the cache line is full (valid bit is 1) and that the cache line contains modified data (dirty bit is 1) that has not been written to main memory. The data in the cache line is subsequently written 112 to main memory, and the dirty bit is set to 0, leading to the (1,0) bit state.

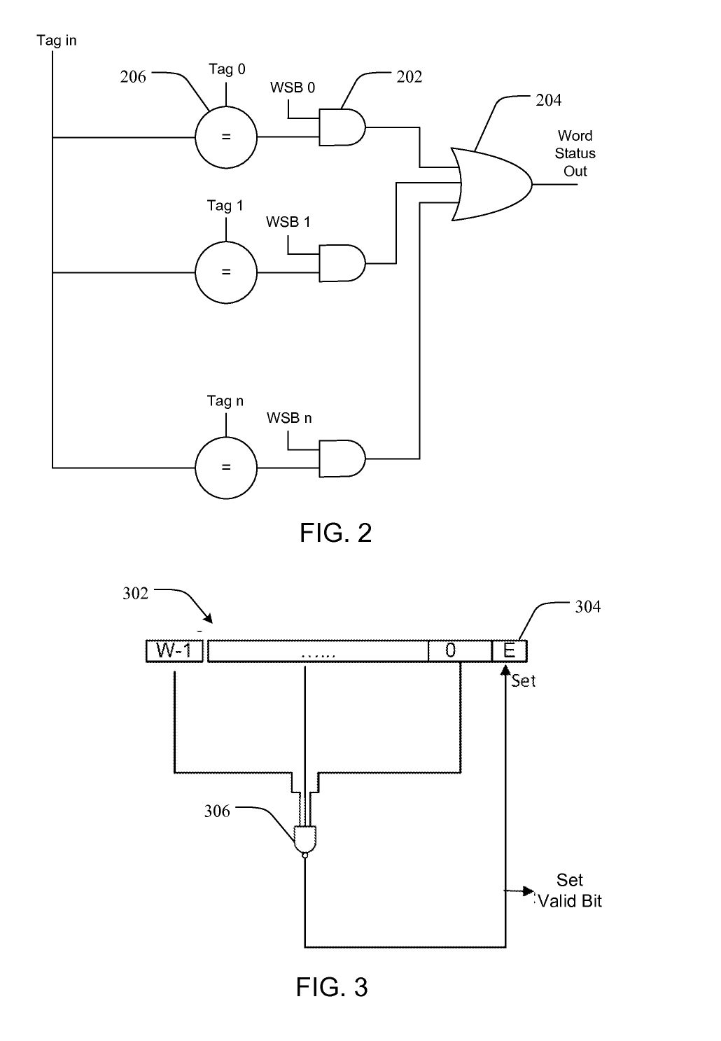

In one example implementation, as shown in FIG. 2, a lookup table circuitry for the PDB is provided. As such, a lookup can be performed to determine the word status bits (WSB 0, 1, . . . n) for a given cache line (Tag 0, 1, . . . n). The circuitry includes AND gates 202 and an OR gate 204. Thus an AND operation is implemented on each word status bit, followed by an OR operation. If Tag 0==the incoming Tag, then the output is WSB 0, and if Tag n==the incoming Tag, then the output is WSB n. For cache lines having the status (0,1), at least one tag will likely match, and the lookup table circuit outputs the partial word status (<W bits>) for that line. Thus, each AND and OR operator indicates a W element array of AND gates and OR gates. Additionally, an n-bit comparator 206 is shown that compares the incoming tag (n bits) with the PDB entry.

FIG. 3 shows a partial slice of an example implementation of the PDB lookup table 302 logic for updating the Empty bit 304 once the cache line has been fully written. Upon partial read misses to a partial dirty line, the cache controller performs a lookup of the PDB to check if a match to the data exists in the cache line. If so, the data is read from the cache to fulfill the read request. If a data match is not present in the cache, the controller performs a fetch of the cache line from main memory and modulates the word mask (word status bits) so that valid words present in the cache line are not written over. The fetched data is written over the non-valid portions of the cache line, and the entry is evicted from the PDB. If all of the word status bits are set to 1, indicating a fully written cache line, the NAND operator 306 outputs a 0 result that sets the Empty bit 304 to 1 and the rest of the line entry to 0. A 1 in the Empty bit indicates that the line entry is empty, and is thus free for the next partial miss/hit assignment. When the entry is cleared or evicted from the PDB, the valid bit in the cache controller tag array is set, indicating that the line is now fully valid. It is noted that numerous circuit designs can be used to implement the logic diagrams depicted herein. Such designs are well known to those of ordinary skill in the art, and would become readily apparent once in possession of the present disclosure.

Accordingly, in one example a cache memory system having a buffer (i.e. PDB) for tracking partial dirty cache lines is provided. Such a system can include circuitry that is configured to receive a partial write request to a cache memory, write data of the partial write request to a location of a cache line of the cache memory, and set word status bits corresponding to the location of the data in the cache line to true. In some examples the circuitry can detect a full state of the cache line from the word status bits and set the valid status bit of the cache line to true. Thus a cache line being tracked by the PDB that becomes full will have the associated valid status bit set to 1 or true, and the PDB will eject the cache line tag from the lookup table and reset the word status bits to 0 or false, thus freeing space for tracking another cache line of partial hit (or miss) data.

In response to receiving the partial write request, the PDB lookup table can be queried to detect matching data (or data having a matching tag) in the cache. Such matching data can be from a previous partial write to the cache line, a portion of a previous full write of the cache line data, or a portion of a previous partial write. In this way, partial hit data can be written to the cache line as opposed to the traditional approach of always fetching a full cache line of data from main memory, and as such, performance can be greatly improved. By tracking and updating the word status bits, partial hit data can be written to the cache until the line if full, at which time the tracking is ejected from the PDB.

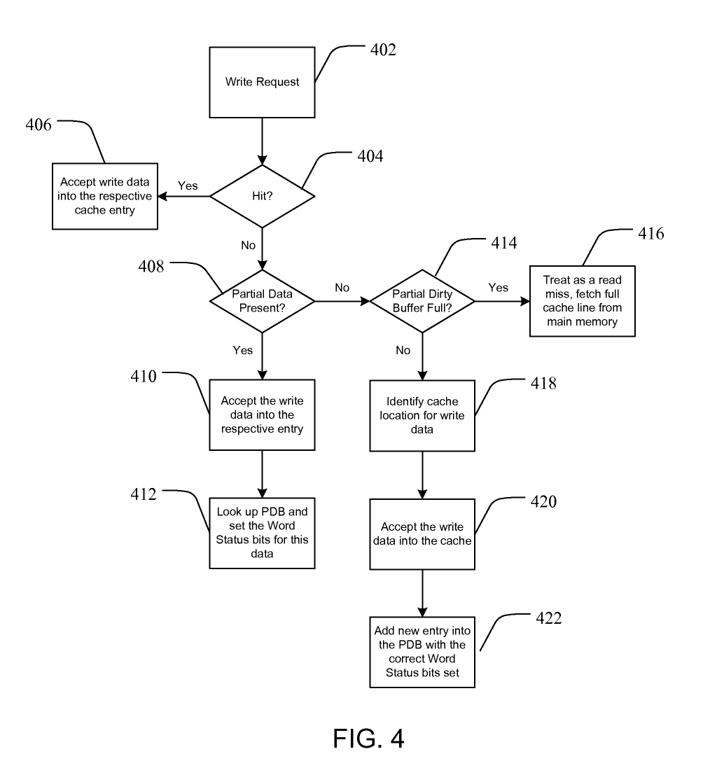

FIG. 4 shows one non-limiting example implementation of a decision flow for writing to a cache having an associated PDB. Upon receiving a write request 402, the cache controller queries the cache lookup table for a write hit 404 of the requested write data. If a full write hit is identified, then the requested write data is accepted into the cache at the respective cache entry 406 for the write hit data. If a full hit is not identified, the presence of a partial write hit (V=0, D=1) is determined 408. If partial write data is present in a cache line, the requested write data is accepted into the cache line at the respective cache entry 410 and the cache controller performs a PDB lookup for the cache line and sets the word status bits 412 to reflect the presence of the newly written data. On the other hand, if partial write data is not present in the cache, a determination is made as to whether or not the PDB is full 414. If the PDB is full, then the write request is treated as a read miss, and the full cache line of the data is fetched from main memory 416 and the fetched data writes over the data in the cache line. If the PDB is not full, a location is identified in the cache 418 and the requested write data is written to the cache location 420. An entry is made in the PDB for the written data, and the word status bits are set to 1 corresponding to the cache location of the written data 422.

Identifying a location in the cache can be accomplished by any technique, many of which are well known to those of ordinary skill in the art. Any algorithm or selection method useful for identifying the location is considered to be within the present scope. In one example, the location can be determined by a cache algorithm. Non-limiting examples of cache algorithms can include Bélády's Algorithm, Least Recently Used, Most Recently Used, Pseudo-Least Recently Used, Random Replacement, Segmented Least Recently Used, 2-way set associative, Direct-mapped cache, Least-Frequently Used, Low Inter-reference Recency Set, Adaptive Replacement Cache, Clock with Adaptive Replacement, Multi Queue, and the like, including appropriate combinations thereof. In one specific example, a Least Recently Used or Pseudo-Least Recently Used algorithm can be implemented.

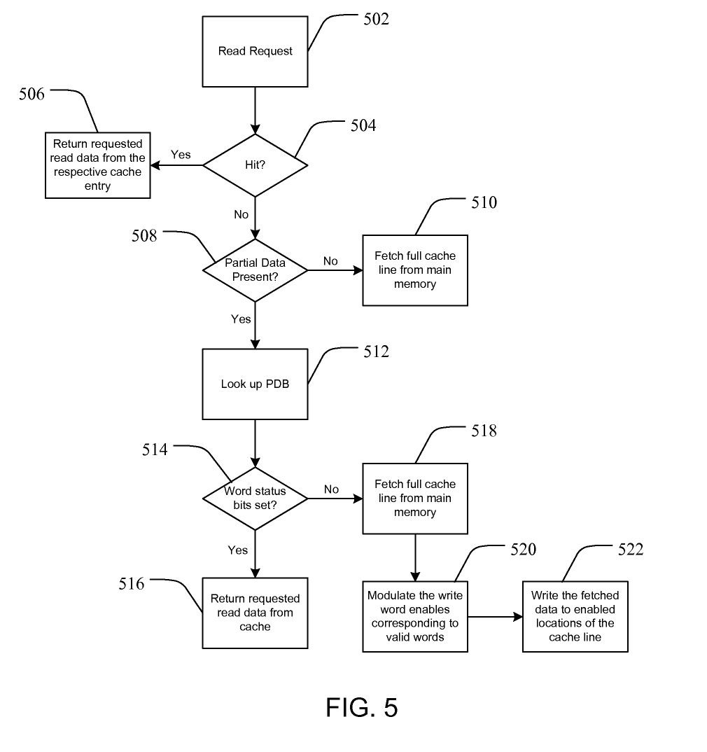

In another example, the system also includes circuitry that is configured to receive a read request for partial hit data, detect matching data in the cache line corresponding to the partial hit data, verify that the word status bits associated with the data are set to true, and read data from the cache line to fulfil the read request. FIG. 5 shows one non-limiting example implementation of a decision flow for reading from a cache having an associated PDB. Upon receiving a read request 502, the cache controller queries the cache lookup table for a read hit 504 of the requested read data. If a full read hit is identified, then the requested read data is returned from the respective cache entry 506. If a full hit is not identified, the presence of a partial read hit (V=0, D=1) is determined 508. If partial read data is not present in the cache, the full cache line with the requested data is fetched from main memory 510. On the other hand, if partial read data is present in the cache, the cache controller performs a PDB lookup 512 to determine if word status bits corresponding to the requested data are set to 1 in 514, or in other words, whether the requested data is valid. If the word status bits are valid, then the requested read data is returned from the cache 516. If the word status bits are not valid, then the full cache line is fetched from the main memory 518, and the write word enables corresponding to any valid words found in the PDB lookup are modulated, or in other words, disabled 520. The fetched data writes over the cache line 522. Because the write word enables are disabled for the valid word locations in the cache, the fetched data only writes over non-valid words in the cache line. Such a “word mask” can be used to selectively write partial hit data to a cache line while leaving valid data already present untouched.

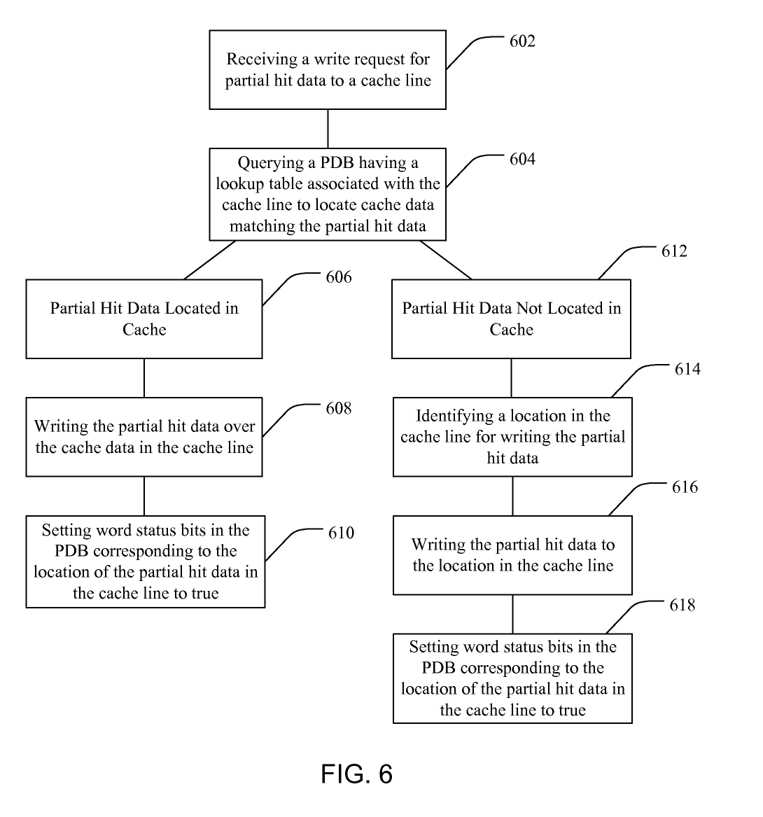

In another example, as is shown in FIG. 6, a method for processing partial write hits in a cache memory system is provided. The method can include 602, receiving a write request for partial hit data to a cache line, and 604, querying a PDB having a lookup table associated with the cache line to locate cache data matching the partial hit data. In response to locating the partial hit data in the cache data 606, the method further includes 608 writing the partial hit data over the cache data in the cache line and 610 setting word status bits in the PDB corresponding to the location of the partial hit data in the cache line to true. In response to not locating partial hit data in the cache data 612, the method further includes 614 identifying a location in the cache line for writing the partial hit data, 616 writing the partial hit data to the location in the cache line, and 618 setting word status bits in the PDB corresponding to the location of the partial hit data in the cache line to true.

In other examples, such methods can additionally include detecting a full state of the cache line from the word status bits, and setting the valid status bit of the cache line to true. As per FIG. 1, such a full cache line will then have a status state of (1,1). The tracking of the cache line can then be ejected from the PDB, and the cache line can be written to the main memory, either at that point or at a later time. It is noted that, upon writing partial hit data to the cache line, if the dirty status bit is set to false, the cache controller will set it to true.

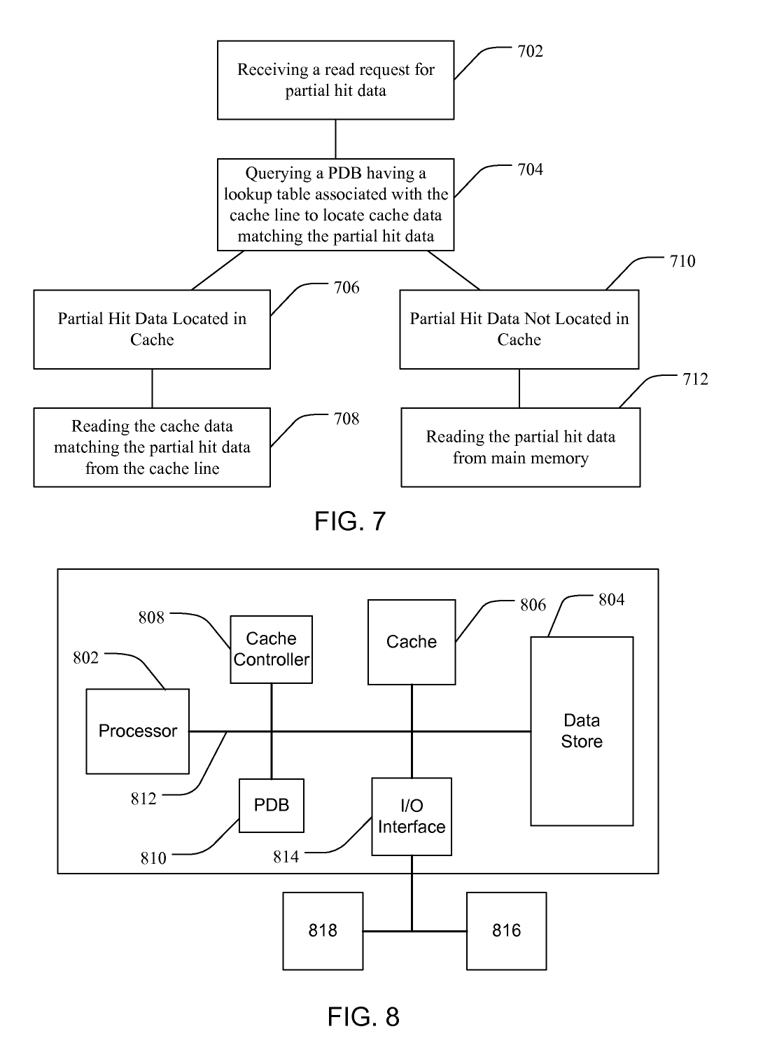

In another example, as is shown in FIG. 7, a method for processing partial read hits in a cache memory system is provided. The method can include 702, receiving a read request for partial hit data, and 704, querying a PDB having a lookup table associated with the cache line to locate cache data matching the partial hit data. In response to locating the partial hit data in the cache data 706, the method further includes 708 reading the cache data matching the partial hit data from the cache line. In response to not locating partial hit data in the cache data 710, the method further includes 712 reading the partial hit data from main memory.

In other examples, the method can also include, in response to locating partial hit data in the cache data, verifying that the word status bits associated with the cache data matching the partial hit data are set to true and reading the cache data from the cache line to fulfill the read request.

It is noted that various error-correcting code memory (ECC) schemes such as, for example, single error correction, double error detection (SECDED) can be implemented over the presently disclosed technology. As one example, the partially dirty cache lines can have a number of ECC bits based on the number of valid words present. The scheme can also be extended to support byte level writes at the cost of additional memory area. Since only the word status bits for each partially modified cache line are being stored in the PDB, the area overhead for this scheme is low. In one example, each word status bit can hold the status for one byte of data in the cache line. In another example, each word status bit can hold the status for one word of data in the cache line. In yet another example, each word status bit can hold the status for more than one word or more than one byte of data in the cache line. Further reduction in area overhead can also be achieved by configuring each word status bit to hold the status of more than one word or more than one byte of data in the cache line. In general, a word status bit can hold the status for one bit of data, one byte of data, one word of data, or more, including size increments in between. In one specific example, the area overhead for a cache line can be equal to the number of bits in the cache tag plus the number of word status bits associated with that cache line. For example, a cache line of B bytes in size and a tag of N bits in size, the number of bits per cache line in the PDB can be (tag (N bits)+(B bits)). It is contemplated that one or more additional bits per cache line can also be present in the PDB, and as such, the PDB entry associated with each cache line should not be limited to merely the tag size and the number of word status bits. However, as the overall scheme is fully associative, the size of the PDB needed to support partially dirty lines at any point of time is minimal.

In another example, a system for processing partial cache hits is provided, and one non-limiting implementation of such a system is shown in FIG. 8. The system can include a processor 802 in communication a data store 804, such as main system memory for example. A cache memory 806 is electrically coupled to the data store 804, and a cache controller 808 is electrically coupled to the cache memory 806. A PDB 810 is electrically coupled to the cache controller 808. The PDB 810 includes a lookup table (not shown) having entry locations to track a number of partial dirty cache lines.

The data store 804 can include any device, combination of devices, circuitry, and the like that is capable of storing, accessing, organizing and/or retrieving data. Non-limiting examples include SANs (Storage Area Network), cloud storage networks, volatile or non-volatile RAM, phase change memory, flash memory, optical media, hard-drive type media, and the like, including combinations thereof.

The system additionally includes a local communication interface 812 for connectivity between the various components of the system. For example, the local communication interface 812 can be a local data bus and/or any related address or control busses as may be desired.

The system can also include an I/O (input/output) interface 814 for controlling the I/O functions of the system, as well as for I/O connectivity to devices outside of the system. The system can additionally include a user interface 816, a display device 818, as well as various other components that would be beneficial for such a system.

The processor 802 can be a single or multiple processors, and the memory 804 can be a single or multiple memories. The local communication interface 812 can be used as a pathway to facilitate communication between any of a single processor, multiple processors, a single memory, multiple memories, the various interfaces, and the like, in any useful combination.

In one example, a system can included a system on a chip (SoC) for processing partial cache hits. The system can include a processor, a main memory coupled to the processor, a cache memory coupled to the processor, a cache memory controller coupled to the cache memory, and a PDB circuit coupled to the cache memory controller. The PDB circuit can further include a lookup table addressed to word status bits of a plurality of cache lines of the cache memory. Furthermore, the cache controller can include circuitry configured to query the lookup table for a location of cache data in the cache memory matching the partial hit data, store the word status bits of the plurality of cache lines, verify values associated with each of the word status bits, and set the values associated with each of the word status bits. In another example, the circuitry configured to set a value of a dirty status bit for each of the plurality of cache lines and set a value of a valid status bit for each of the plurality of cache lines.

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In addition to, or alternatively to, volatile memory, in one embodiment, reference to memory devices can refer to a nonvolatile memory device whose state is determinate even if power is interrupted to the device. In one embodiment, the nonvolatile memory device is a block addressable memory device, such as NAND or NOR technologies. Thus, a memory device can also include future generation nonvolatile devices, such as a three dimensional crosspoint memory device, or other byte addressable nonvolatile memory device. In one embodiment, the memory device can be or include multi-threshold level NAND flash memory, NOR flash memory, single or multi-level Phase Change Memory (PCM), a resistive memory, nanowire memory, ferroelectric transistor random access memory (FeTRAM), magnetoresistive random access memory (MRAM) memory that incorporates memristor technology, or spin transfer torque (STT)-MRAM, or a combination of any of the above, or other memory.

### Examples

The following examples pertain to specific invention embodiments and point out specific features, elements, or steps that can be used or otherwise combined in achieving such embodiments.

In one example there is provided, a cache memory system having a buffer for tracking partial dirty cache lines, the cache memory system comprising circuitry configured to:

receive a partial write request to a cache memory;

write data of the partial write request to a location of a cache line of the cache memory; and

set word status bits corresponding to the location of the data in the cache line to true.

In another example there is provided, a cache memory system comprising:

buffer circuitry for tracking partial dirty cache lines; and

circuitry configured to:
receive a partial write request to a cache memory;
write data of the partial write request to a location of a cache line of the cache memory; and

set word status bits corresponding to the location of the data in the cache line to true.

In one example of a cache memory system, the circuitry is further configured to:

detect a full state of the cache line from the word status bits; and

set a valid status bit of the cache line to true.

In one example of a cache memory system, the circuitry is further configured to write the cache line data to a main memory.

In one example of a cache memory system, the circuitry is further configured to set the word status bits of the cache line to false.

In one example of a cache memory system, in response to receiving the partial write request, the circuitry is further configured to detect matching data from a previous partial write in the cache line.

In one example of a cache memory system, in response to matching data in the cache line, the circuitry is further configured to write the data of the partial write request to the cache line, wherein the location is the location of the matching data.

In one example of a cache memory system, in response to no matching data in the cache line, the circuitry is further configured to write the data of the partial write request to the cache line, wherein the location is any location of the cache line.

In one example of a cache memory system, the location is determined by a cache algorithm.

In one example of a cache memory system, the location is determined by a cache algorithm selected from the group consisting of Bélády's Algorithm, Least Recently Used, Most Recently Used, Pseudo-Least Recently Used, Random Replacement, Segmented Least Recently Used, 2-way set associative, Direct-mapped cache, Least-Frequently Used, Low Inter-reference Recency Set, Adaptive Replacement Cache, Clock with Adaptive Replacement, Multi Queue, and combinations thereof.

In one example of a cache memory system, the location is determined by a Least Recently Used cache algorithm.

In one example of a cache memory system, the circuitry is further configured to:

receive a read request for partial hit data;

detect matching data in the cache line corresponding to the partial hit data;

verify the word status bits associated with the data are set to true; and

read data from the cache line.

In one example of a cache memory system, in response to writing the data of the partial write request to the location of the cache line, the circuitry is further configured to set a dirty status bit to true.

In one example of a cache memory system, the circuitry further comprises:

a cache memory; and

a cache controller coupled to the cache memory, wherein the buffer circuitry is coupled to the cache controller and further comprises a lookup table.

In one example there is provided, a method for processing partial write hits in a cache memory system, comprising:

receiving a write request for partial hit data to a cache line;

querying, using a cache controller, a partial dirty buffer (PDB) having a lookup table (LUT) associated with the cache line to locate cache data matching the partial hit data;

in response to locating cache data;

writing the partial hit data over the cache data in the cache line; and

setting word status bits in the PDB corresponding to a location of the partial hit data in the cache line to true;

in response to not locating cache data;

identifying a location in the cache line for writing the partial hit data;

writing the partial hit data to the location in the cache line; and

setting word status bits in the PDB corresponding to the location of the partial hit data in the cache line to true.

In one example of a method for processing partial write hits, the method further comprises:

detecting a full state of the cache line from the word status bits; and

setting a valid status bit of the cache line to true.

In one example of a method for processing partial write hits, the method further comprises writing the cache line data to a main memory.

In one example of a method for processing partial write hits, the method further comprises identifying the location for writing the partial hit data by a cache algorithm.

In one example of a method for processing partial write hits, identifying the location is by a cache algorithm selected from the group consisting of Bélády's Algorithm, Least Recently Used, Most Recently Used, Pseudo-Least Recently Used, Random Replacement, Segmented Least Recently Used, 2-way set associative, Direct-mapped cache, Least-Frequently Used, Low Inter-reference Recency Set, Adaptive Replacement Cache, Clock with Adaptive Replacement, Multi Queue, and combinations thereof.

In one example of a method for processing partial write hits, identifying the location is by a Pseudo-Least Recently Used cache algorithm.

In one example of a method for processing partial write hits, writing the partial hit data further comprises setting a dirty status bit to true.

In one example there is provided, a method for processing partial read hits in a cache memory system, comprising:

receiving a read request for partial hit data;

querying a partial dirty buffer (PDB) lookup table (LUT) associated with a cache line to locate cache data matching the partial hit data;

reading, in response to locating the cache data, the cache data from the cache line; and

reading, in response to not locating the cache data, the partial hit data from a main memory.

In one example of processing partial read hits, reading, in response to locating the cache data, the cache data from the cache line, further comprises:

verifying the word status bits associated with the cache data are set to true; and

reading the cache data from the cache line.

In one example there is provided, a system on a chip (SoC) for processing partial cache hits, comprising:

a processor;

a main memory coupled to the processor;

a cache memory coupled to the processor;

a cache memory controller coupled to the cache memory; and

a partial dirty buffer circuit coupled to the cache memory controller.

In one example of a system on a chip (SoC) for processing partial cache hits the partial dirty buffer circuit further comprises a lookup table (LUT) addressed to word status bits of a plurality of cache lines of the cache memory.

In one example of a system on a chip (SoC) for processing partial cache hits the cache memory controller further comprises circuitry configured to:

query the LUT for a location of cache data in the cache memory matching the partial hit data;

store the word status bits of the plurality of cache lines;

verify values associated with each of the word status bits; and

set the values associated with each of the word status bits.

In one example a system on a chip (SoC) for processing partial cache hits the partial dirty buffer circuit further comprises circuitry configured to:

set a value of a dirty status bit for each of the plurality of cache lines; and

set a value of a valid status bit for each of the plurality of cache lines.

In one example a system on a chip (SoC) for processing partial cache hits further comprises an I/O interface coupled to the processor.

In one example of a system on a chip (SoC) for processing partial cache hits the I/O interface further comprises an interface selected from the group consisting of USB, Bluetooth, Bluetooth Low Energy, wireless internet, cellular, Ethernet, USART, SPI, FireWire, and combinations thereof.

What is claimed is:

1. A cache memory system, comprising:
buffer circuitry to track partial dirty cache lines; and
circuitry configured to:
receive a partial write request to a cache memory;
write data of the partial write request to a location of a cache line of the cache memory; and
set word status bits corresponding to the location of the data in the cache line to true.

2. The system of claim 1, wherein the circuitry is further configured to:
detect a full state of the cache line from the word status bits; and
set a valid status bit of the cache line to true.

3. The system of claim 2, wherein the circuitry is further configured to write the cache line data to a main memory.

4. The system of claim 3, wherein the circuitry is further configured to set the word status bits of the cache line to false.

5. The system of claim 1, wherein, in response to receipt of the partial write request, the circuitry is further configured to detect matching data from a previous partial write in the cache line.

6. The system of claim 5, wherein, in response to matching data in the cache line, the circuitry is further configured to write the data of the partial write request to the cache line, wherein the location is the location of the matching data.

7. The system of claim 5, wherein, in response to no matching data in the cache line, the circuitry is further configured to write the data of the partial write request to the cache line, wherein the location is any location of the cache line.

8. The system of claim 7, wherein the location is determined by a cache algorithm selected from the group consisting of Bélády's Algorithm, Least Recently Used, Most Recently Used, Pseudo-Least Recently Used, Random Replacement, Segmented Least Recently Used, 2-way set associative, Direct-mapped cache, Least-Frequently Used, Low Inter-reference Recency Set, Adaptive Replacement Cache, Clock with Adaptive Replacement, Multi Queue, and combinations thereof.

9. The system of claim 1, wherein the circuitry is further configured to:
receive a read request for partial hit data;
detect matching data in the cache line corresponding to the partial hit data;
verify the word status bits associated with the data are set to true; and
read data from the cache line.

10. The system of claim 1, wherein, in response to a write of the data of the partial write request to the location of the cache line, the circuitry is further configured to set a dirty status bit to true.

11. The system of claim 1, wherein the circuitry further comprises:
a cache memory; and
a cache controller coupled to the cache memory, wherein
the buffer circuitry is coupled to the cache controller and comprises a lookup table.

12. A method for processing partial write hits in a cache memory system, comprising:
receiving a write request for partial hit data to a cache line;
querying, using a cache controller, a partial dirty buffer (PDB) having a lookup table (LUT) associated with the cache line to locate cache data matching the partial hit data;
in response to locating cache data;
writing the partial hit data over the cache data in the cache line; and
setting word status bits in the PDB corresponding to a location of the partial hit data in the cache line to true;
in response to not locating cache data;
identifying a location in the cache line for writing the partial hit data;
writing the partial hit data to the location in the cache line; and
setting word status bits in the PDB corresponding to the location of the partial hit data in the cache line to true.

13. The method of claim 12, further comprising:
detecting a full state of the cache line from the word status bits; and
setting a valid status bit of the cache line to true.

14. The method of claim 13, further comprising writing the cache line data to a main memory.

15. The method of claim 12, wherein identifying the location is by a cache algorithm selected from the group consisting of Bélády's Algorithm, Least Recently Used, Most Recently Used, Pseudo-Least Recently Used, Random Replacement, Segmented Least Recently Used, 2-way set associative, Direct-mapped cache, Least-Frequently Used, Low Inter-reference Recency Set, Adaptive Replacement Cache, Clock with Adaptive Replacement, Multi Queue, and combinations thereof.

16. The method of claim 12, wherein writing the partial hit data further comprises setting a dirty status bit to true.

17. A method for processing partial read hits in a cache memory system, comprising:
receiving a read request for partial hit data;
querying a partial dirty buffer (PDB) lookup table (LUT) associated with a cache line to locate cache data matching the partial hit data;
reading, in response to locating the cache data, the cache data from the cache line; and
reading, in response to not locating the cache data, the partial hit data from a main memory.

18. The method of claim 17, wherein reading, in response to locating the cache data, the cache data from the cache line, further comprises:
verifying the word status bits associated with the cache data are set to true; and
reading the cache data from the cache line.

19. A system, comprising:
a processor;
a main memory coupled to the processor;
a cache memory coupled to the processor;
a cache memory controller coupled to the cache memory; and
a partial dirty buffer circuit coupled to the cache memory controller.

20. The system of claim 19, wherein the partial dirty buffer circuit further comprises a lookup table (LUT) addressed to word status bits of a plurality of cache lines of the cache memory.

21. The system of claim 20, wherein the cache memory controller further comprises circuitry configured to:
query the LUT for a location of cache data in the cache memory matching the partial hit data;
store the word status bits of the plurality of cache lines;
verify values associated with each of the word status bits; and
set the values associated with each of the word status bits.

22. The system of claim 21, wherein the partial dirty buffer circuit further comprises circuitry configured to:
set a value of a dirty status bit for each of the plurality of cache lines; and
set a value of a valid status bit for each of the plurality of cache lines.

23. The system of claim 19, further comprising an I/O interface coupled to the processor.

24. The system of claim 23, wherein the I/O interface further comprises an interface selected from the group consisting of USB, Bluetooth, Bluetooth Low Energy, wireless internet, cellular, Ethernet, USART, SPI, FireWire, and combinations thereof.
